(19) United States
(12) Patent Application Publication
(10) Pub. No.: US 2026/0249431 A1
(43) Pub. Date: Aug. 27, 2026

(54) Push On Pull Off Wrench

(71) Applicant: ATE International Ltd, Leicestershire (GB)

(72) Inventor: Nigel Buchanan, Fife (GB)

(21) Appl. No.: 18/290,843

(22) PCT Filed: Jul. 21, 2022
(86) PCT No.: PCT/GB2022/051912

§ 371 Date: Jan. 22, 2024

(30) Foreign Application Priority Data
Jul. 21, 2021 (GB) 2110473.2

(51) Int. Cl. B25B 13/48

(52) U.S. Cl. CPC B25B 13/481

(57) ABSTRACT

The head portion (400) inwardly curved profile fastener access (304) when pushed against the worked fastener drive flats (82) can open against a resilient bias (70), allowing the fastener (80) to directly access the inner operating profile (302), when the fastener (80) is inserted the head portion (300) automatically closes, operation of the turning means (20) urging the fastener head (81) into engagement with the pivotal head portion torque application points (402), (403), (404), locking said fastener head (81) within the pivotal head inner drive profile (401), further pivoting around the pivot pin (60) robustly forcing said fastener head (81) against the fixed head portion torque application points (501), (502), all radiused leading edges (306) facing in the drive torque direction D. The majority of said inner operating profile (302) adjoining the second and third torque application points (403), (404) concave arcuate corner profile (310) is scalloped out forming an arcuate pathway (410) allowing passage of the adjacent fastener corner point (84), permitting ratcheting in the reverse R manner about the worked fastener head (81).

### FIELD OF THE INVENTION

The present invention relates to wrenches (also known as “spanners” in the United Kingdom), and in particular to opening box or ring wrenches used to circumvent obstructing tubes, pipes etc. attached to the fitting to be operated.

### BACKGROUND TO THE INVENTION

Pipes or tubes utilise pipe or tube nuts or fasteners to connect the pipework to the various hydraulic, pneumatic or just fluid or air machines or controls. The tube nuts utilised are generally made from brass or other “soft” metals which can be easily damaged during dismantling especially when corrosion or the like causes the tube nut to be tighter than expected. When used on tight fasteners normal open ended or crowfoot wrenches tend to round off the corners of the flare nut drive flats often to a stage that they become inoperable.

In order to impart as much torque as possible to the worked flare nut or similar, various devices have been designed, in particular Buchanan U.S. Pat. No. 7,073,413 consisting of a fold out flexible ring portion having an inner working surface for the engagement of the worked fastener. Buchanan U.S. Pat. No. 7,073,413 denotes a very robust wrench, the spring steel wrench head designed to grip the worked fastener in a torque tightening manner, the more torque applied to the handle the greater the grip imparted by the wrench head upon the worked fastener. This wrench normally requires, to be removed from the flare nut hex drive then re-attached every time the wrench reaches the limit of its operational travel.

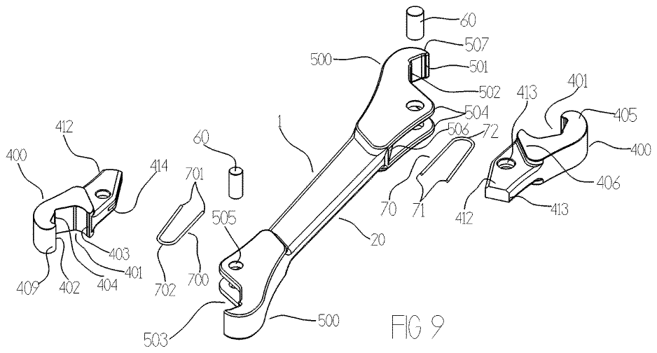

A further ratcheting wrench being the commercial version of Buchanan U.S. Pat. No. 6,978,701 as illustrated in FIGS. 12 and 13, whereas in commercial production a compression spring is further utilised between segment 20d and 20c, the segments having further elongate portions with bores for the utilisation of the compression spring situated out with the wrench head circumference in order that the resilient portion can impart an effective closing action upon the opening portion 20d, 20e, 20f the said segments opening in a cantilever like fashion, the said wrench head being capable of “ratcheting” 60 deg. from one fastener flat to the next when operated in the reverse direction. The resilient action shown in FIG. 13 is incorporated into the chain link like hinges or similar, although commercially very successful these wrenches could not be utilized in all situations. The appendages containing the compression spring resilient bias although very effective in closing the wrench segments curtails the use of the wrench when the gap between the fastener and any adjacent equipment is close. As the spring bores employed are inherently shallow the compression springs utilized are near or at their solid compression points when compressed which has in some circumstances led to kinking, bulging and premature failure. Furthermore the characterizing feature of U.S. Pat. No. 6,978,701 upon which all claims are based is the wedge shaped flexible ring portion increases in width towards the free end of the said cantilevered-ring portion. An even further distinct disadvantage of this design is the opening of this wrench head design further normally requires the use of two hands.

PCT/GB 2018/050702 Buchanan comprises a line wrench with a thumb switch operable pivotal ring portion and incumbent fastener engagement faces encompassing approximately 50% of the wrench head inner profile, the fixed ring portion encompassing approximately the other 50% of the wrench head inner profile. The said switch, pivotal and fixed ring portion substantial joint portions being at approximately 90 deg to the handle portion, which in some circumstances can cause problems when operated near obstructions. The head portion fastener access opening at around 75% of the operated hexagonal fastener across the flat size, is substantially less than that of any operated hexagonal fastener across the flat measurement meaning like all prior art closing box or ring wrenches it requires to be fitted to the lesser width fastener elongate attachment first, then secondly placed in the operating position and the same operation in the removal procedure. The compression spring resilient closure means requires the use of elongate spring bores in both the pivotal and fixed head portions, the production process further requiring costly secondary drilling or a MIM (metal injection moulding) moving core in the moulding process.

The undoubted inherent strength of the mechanism is derived from the closure mechanism, in use the pivotal ring portion free end engages in a locking procedure with the fixed cam face, the greater the torque applied to the wrench head portion the greater the locking and head compression force, the construction requires the implementation of high grade spring steel as the head segments require to flex at their incorporated sprung hinge like intersections as the head portion torque tightens upon the fastener head driven half faces.

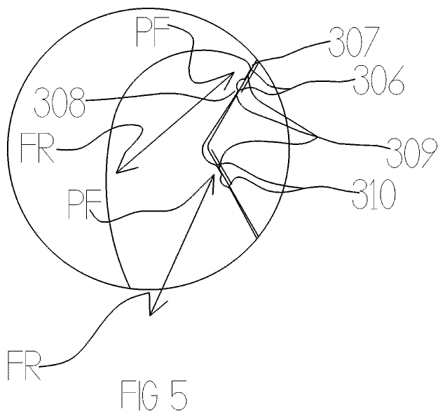

U.S. Pat. No. 9,884,409 as claimed, by the Chinese manufacturers for over 10 years at that point of the U.S. Pat. No. 6,978,701 manufactured device, is in essence an upside down near carbon copy version of the U.S. Pat. No. 6,978,701 manufactured product, including the driving face profiles 12, 42, the cantilever links 20, the locking members 31, 32, the resilient portion 50 and its recesses 16. However the forces produced in a device made to the U.S. Pat. No. 9,884,409 are now quite different and require the first and second protrusions 17, 41 to remain locked together to work, as illustrated in FIG. 5, this, the essential factor however is not claimed. As further shown in FIG. 6 the drive face 12 near the first end portion 15 is clearly not in contact with the corresponding fastener 60 driven face as this space is required in order to allow the fastener to “ratchet” within the “hexagonal space”.

The wrench head also has a pivoting head portion 40 that has a free end portion 44. As described in column 3, lines 32 to 35 of U.S. Pat. No. 9,884,409 and shown in FIGS. 5 and 6, to close the wrench head around a fastener 60 the free end portion 44 of the pivoting head portion 40 is moved along the inner side of the free end portion 15 of the fixed head portion 10 and “inserted into the recess 14”. Thus, with reference to FIGS. 5 and 6 it can be seen that when the pivoting head portion 40 is pivoted towards the fixed head portion 10 to close the wrench head around a fastener 60, the free end 44 of the pivoting head portion 40 merely clicks into the recess 14 in the fixed head portion 10. When a torque is applied to tighten there is no camming action that will increase the engagement between the fixed head portion 10 and pivoting jaw portion 40. If the pivoting jaw portion 44 were allowed to move further into the fixed head portion 10 from the position shown in FIGS. 5 and 6, there would be no increase in engagement between them. This is because two concave regions, the fixed head portion second recess 14 and the corresponding un-numbered concave region adjacent the second end portion 44 would move opposite one another so that there would in fact be a reduction in the engagement between the two parts. However, any opening movement is effectively prevented by the engagement of the first protrusion 17 and second protrusion 47 (see FIG. 5 and column 3, line 37), thus the wrench head disclosed in U.S. Pat. No. 9,884,409 cannot tighten onto a fastener 60 as increasing torque is applied. This means that for slightly undersized fasteners or fasteners 60 whose sides have been worn away, damaged or rounded off, there is a considerable risk that the U.S. Pat. No. 9,884,409 wrench head will slip off or further damage said fastener 60.

Sparling U.S. Pat. No. 4,967,612 which is a combination of known open wrench and known socket has an inherent problem in that it requires to “lock onto” a workpiece or fastener before any useful work can be done. Particularly any device made according to U.S. Pat. No. 4,967,612 is the proportion of the supplied torque arm force required to sustain the gripping members useful grip upon the workpiece or fastener. If the proportion of locking force is incorrect the gripping members (flexible sockets) grip upon the fastener would be insufficient to prevent the gripping members (flexible socket) from opening under normally occurring torque levels leading to “slippage” between the workpiece and flexible socket.

In practice a similar sized device made to U.S. Pat. No. 4,967,612 has less than 20% of the locking force for the same applied torque arm force compared to the present invention.

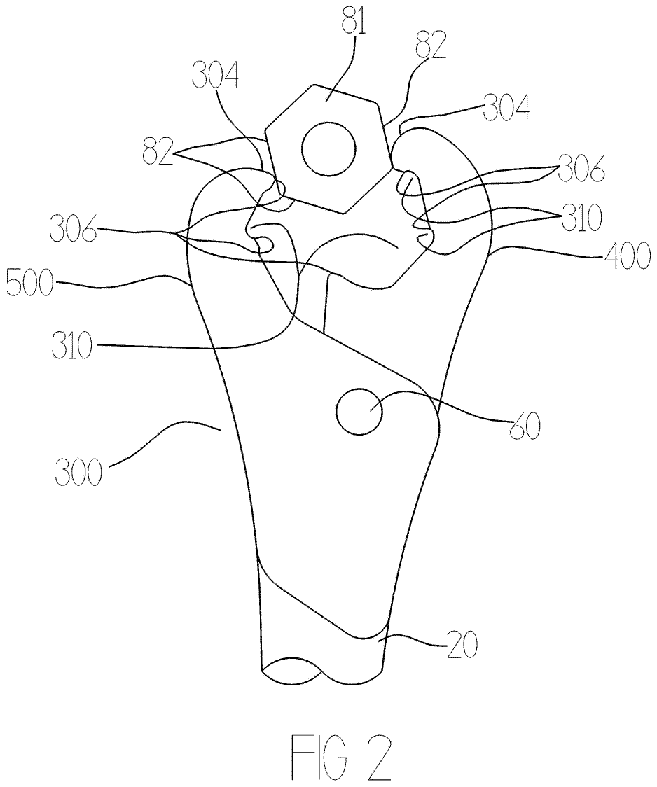

U.S. Pat. No. 7,146,884 denotes a two jaw open end wrench, head 14, according to claim 1, 6, 10 and 14 comprising two adjacent bite surfaces 24, 32 “disposed at an angle (Ft, Fc) greater than or equal to about 15 degrees and less than or equal to about 30 degrees with respect to the body axis” FIGS. 2B, 2C, 2D and in particular 2E, “between them a throat (web)” 18. Further claimed in claim 2, “wherein the (single) bite edges 29, 31 are of sufficient sharpness to plow into the fastener 36 sides” 46, 48 in order to drive the operated fastener 36 as illustrated in FIGS. 2E and 2F depicting the actual operation. As further described in the detailed description, “Plowing” “refers to the jaw bite edges and surfaces digging into the fastener head so that fastener material builds up in front of the bite surface”, “in order to achieve adequate plowing, the bite surfaces must be adequately sharp”. The operated fastener 36 if tight to operate would be damaged and in most circumstances leaving problematic sharp burrs. Furthermore claim 3 is specific in no engagement with a third torque application point. All the associated patents were allowed to lapse during or after 2010 US 2019/0118354 denotes a ratcheting line wrench with two separate single tooth ratchet pawls according to the drawings one utilized for each switchable direction. The central socket being interchangeable, said socket being typical of that utilized in a ratcheting wrench but with a section removed to allow the fastener elongate attachment to be overcome and the fastener drive flats to be engaged, this device as depicted would be an innately low torque device the main reason being the minimally small possible level of pawl teeth engagement.

It is an object of the present invention to provide an uncomplicated tool that can be easily remotely operated using one hand, capable of direct fastener access, needs no locking mechanism, working on near sized metric/inch fasteners, capable of working on undersized or extremely worn/damaged fasteners whilst being intuitive and robust in use, yet less expensive to manufacture. It is a further object of the push on pull off wrench, to at least partially alleviate any of the aforementioned disadvantages, or to provide an alternative to existing products.

### SUMMARY OF THE INVENTION

The invention provides a push on pull off wrench incorporating a resilient closure bias and a protective location for the resilient closure bias utilized, in accordance with the invention there is provided a push on pull off wrench having a head portion adapted to engage and apply torque in particular but not exclusively to a fastener such as a brake pipe fitting, or flare nut attached to a tube or pipe and a turning means for operating said head portion. Said head portion being in two main pieces, a first pivotal head portion attached to a second fixed head portion by a pivot pin, the pivotal head portion further resiliently urged towards the closed position by a resilient bias means, said pivotal head portion having torque application points within the head portion inner operating profile for engagement with the normally hexagonally faceted flare nut, hydro-vac, plain fastener or any nut type pipe connector fitting drive surfaces (hereinafter termed a fastener) to be worked, the said fixed head portion operating profile having further compatible torque application points, all the torque application points having radiused leading edges, all said radiused leading edges facing in the drive torque direction.

In use the head portion is opened by the application of the head portion inwardly curved fastener access profiles at the point of the head portion access gap upon the fastener drive flats. As the push on pull off wrench 1, head portion 300 inwardly curved or angled fastener access profile is urged against the fastener drive flats the pivotal head portion opens without the any requirement of a push switch actuation portion, against the resilience of the resilient bias means, the pivotal head portion opening sufficiently to allow the fastener drive flats to be directly circumnavigated, then encompassed by the head portion inner operating profile, in order to directly engage the fastener drive flats to be worked without first overcoming any associated fastener elongate attachment, this being extremely advantageous when the fastener to be worked has limited access. Further operation of the turning means in the drive direction urges the fastener drive flats into engagement with the pivotal head portion torque application points, only the hexagonal fastener head, driven half faces are therefore now engaged by the pivotal head portion torque application points. The pivotal head portion with its incumbent hexagonal fastener head as it pivots around the pivot pin is forced towards the fixed head portion inner drive profile engaging the said hexagonal fastener head within the additional fixed head portion torque application points, resulting in a very robust five torque application point engagement of the fastener to be worked by the head portion inner operating profile.

When the push on pull off wrench is operated in the reverse or reposition direction the pivotal head portion swivels open around the pivot pin against the resistance of the resilient bias means until the pivotal head portion torque application points lose their grip upon their corresponding fastener flats. The pivotal head portion, inner operating profile adjoining the second torque application point rear aspect and third torque application point concave arcuate corner profile, is scalloped out for the formation of an arcuate pathway for the required passage of the adjacent fastener corner point, allowing the pivotal head portion inner operating profile to be operated in the reverse or reposition direction in a ratchet like manner about the worked fastener driven half faces to different drive positions without removing the wrench head portion completely from the corresponding fastener head, as the said wrench head portion is reversed or repositioned upon the worked hexagonal fastener head, the abutting fastener corner point against the corresponding guide face situated between the second and third tooth concave arcuate corner profiles further helps urge the adjoining fastener drive flat to pivot around the first jaw rolling face whilst the directly opposing fastener corner point can easily travel outwards from the confines of the pivotal head portion inner operating profile via the arcuate pathway indented between the second and third torque application point until the first torque application point can engage the next available worked fastener driven half face, or any further worked fastener driven half face as required.

In the first embodiment of the push on pull off wrench the head portion inner drive profile is notionally hexagonal in shape. This notionally hexagonal inner operating profile having as required indentations at the vertices in the shape of concave arcuate corner profiles, the radiused leading edge of the torque application points, formed at the point of convergence between the torque application point flat faces and concave arcuate corner profiles create the first, third and fourth low profile radiused leading edges, said radiused leading edges capable of engaging correspondingly sized fastener drive flat driven half faces in the direction of torque application, all inner operating profile radii chosen to prevent stress distortion or cracks under high torque use. In an even further embodiment of the push on pull off wrench, the ultimate opening of the pivotal head portion can result in a head portion access gap substantially over 100% of the corresponding fastener drive flat to opposing fastener drive flat width, allowing complete ease of direct fitment or removal of the worked hexagonal fastener head with regards to a correspondingly sized head portion inner operating profile.

In an even further embodiment of the push on pull off wrench, the first and third torque application points utilized, grip the corresponding worked fastener driven half faces, acting to pull around said worked fastener drive flats in the direction of torque application, whereas the second fourth and fifth third torque application points utilized act to push around their corresponding worked fastener driven flat faces in the direction of the projected force application. The projected force applied to the fastener head driven half faces, is concentrated by the use of the corresponding torque application points radiused leading edges and flat faces gripping the corresponding fastener driven half faces of the fastener drive flats, all radiused leading edges facing in the drive torque direction. In best practice when used on properly sized undamaged fasteners the torque application points radiused leading edges are situated at generally equidistant points from the operated fastener corner points within the length of the operated fastener driven half faces, this is done in order to equalize as far as possible the projected force or torque that can be applied to operate the worked fastener hexagonal head, whilst minimizing the damage to either the head portion, torque application points, fastener driven half faces or corner points. The optimum point of engagement between the said radiused leading edges and the fastener corner points adjacent the fastener driven half faces, when used on properly sized undamaged hexagonal fastener heads is approximately 8-20% of the length of the operated fastener drive flat from said fastener corner points and in best practice requires to be no more than 4 mm in from the adjoining fastener corner points on even the largest push on pull off wrench, head portion sizes.

An even further embodiment of the push on pull off wrench, whereas the pivotal head portion inner drive profile comprises in best practice three separate gripping points hereinafter termed torque application points, one engaging each corresponding fastener driven half face in the direction of the projected force application, the occurring force reactions within the pivotal head portion usefully projected into the deep robust head portion outer profile. The pivotal head portion, three torque application point profile purposely directs and tends to equalize its projected force upon the worked fastener drive flats when operated in the chosen drive torque direction.

In an even further embodiment of the push on pull off wrench, when a suitable hexagonal fastener head is already engaged within the pivotal head portion inner drive profile and operated in the drive torque direction, whereas as the pivotal head portion pivots closed around its pivot pin, is the additional interaction of the corresponding remaining fastener head driven flats with a further two sets of torque application points incorporated within the fixed head portion inner drive profile. The greater the lever arm force applied to the turning means, the greater the clamping force between the pivotal head portion and fixed head portion torque application points, thus further greatly increasing the grip from that imparted by only the pivotal head portion torque application points upon the incumbent worked fastener driven half faces.

In an even further embodiment of the push on pull off wrench the overall head portion being in two main pieces, a pivotal head portion attached to a fixed head portion generally at the pivotal head portions central point by a pivot pin and further operable by a push switch actuator incorporated towards the turning means end.

In an even further embodiment of the push on pull off wrench the pivotal head portion is resiliently urged towards the closed position by a resilient bias means in best practice in the form of a U shaped wire torsion spring held around the pivot pin with the resilient bias means legs acting upon both the said fixed and opening portions of the said wrench head portion in order to resiliently bias the said pivotal head portion inner drive profile inwards towards the said fixed head portion, it is obvious that other types and profiles of springs can be used. In order to produce a ratchet like action between the head portion and the operated fastener, the pivotal head portion is resiliently biased into the closed position by the resilient bias means. This sprung hinge like mechanism allows the said pivotal head portion to swivel open, not only allow the said wrench head inner profile to usefully access the fastener drive flats but allow the pivotal head portion to usefully open enough against the said resilient bias means to allow the head portion to be repositioned in the reverse direction onto the next fastener drive face or drive corner ready for the next drive sequence. The said pivotal head portion can be further optionally swivelled open against the force of the resilient portion, by a push switch actuator incorporated within the pivotal head portion, for the purpose of accessing or withdrawal from the fastener drive flats or the circumference of any fastener elongate attachment.

In an even further embodiment of the push on pull off wrench, the majority of the inner drive profile adjoining the second and third tooth concave arcuate corner profiles, is scalloped out to form a concave fillet for the formation of the arcuate pathway allowing the required passage of the adjacent fastener corner point, permitting the wrench to be ratcheted in the reverse or reposition R manner about the worked fastener driven half faces to different drive positions without removing the wrench head portion completely from the corresponding fastener head, as the said wrench head portion is reversed or repositioned upon the worked hexagonal fastener head the abutting fastener corner point against the corresponding guide face helps urge the adjoining fastener drive flat to pivot around the first tooth rolling face whilst the opposing fastener corner point can easily travel outwards from the confines of the inner drive profile via the arcuate pathway until the first drive tooth can engage the next available worked fastener driven half face, or any further worked fastener driven half face as required.

In an even further embodiment of the push on pull off wrench, the notionally hexagonal shaped wrench head inner drive profile can be slightly oversized compared to the hexagonal fastener head worked, this allows the said worked fastener head to rotate very slightly bringing the torque application point radiused leading edges to grip the corresponding fastener driven half faces in an enhanced manner, this novel inner drive profile is further capable of robustly operating damaged, 5% undersized or near undersized inch/metric fastener sizes.

In an even further embodiment of the push on pull off wrench, incorporates a turning means square drive for operation by known square drive extensions drive bars etc. (not shown).

While one or more preferred embodiments of the preferred invention have been described above, it should have been understood that any and all equivalent realisations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope of appended claims.

### A MARSHALING OF REFERENCE NUMERALS UTILIZED IN THE DRAWINGS

Following is a listing of the various components used in the best mode preferred embodiment and alternative embodiments. For the ready reference of the reader the reference numerals have been arranges in ascending numerical order.

1/Push On Pull Off Wrench
20/Turning Means
300/Head Portion
301/Head Portion Outer Profile
302/Head Portion Inner Operating Profile
303/Head Portion Notionally Hexagonal Operating Profile
304/Head Portion Inwardly Curved Profile Fastener Access
305/Head Portion Fastener Access Gap
306/Torque Application Point Radiused Leading Edges
307/Leading Edge Front Aspect
308/Torque Application Point Rear Aspect
309/Torque Application Point Flat Faces
310/Concave Arcuate Corner Profiles
311/Angled Fastener Access Profile
312/Torque Application Point Arcuate Recesses
400/Pivotal Head Portion
401/Pivotal Head Portion Inner Drive Profile
402/First Torque Application Point
403/Second Torque Application Point
404/Third Torque Application Point
405/First Jaw
406/Second Jaw
407/Second Jaw Outer Point
408/Resilient Bias Retaining Slot
409/First Jaw Rolling Face
410/Arcuate Pathway
411/Planar Guide Face
412/Inner Swivel Layer
413/Pivot Pin Bore
414/Push Switch Actuator
415/Resilient Bias Wall
500/Fixed Head Portion
501/Fourth Torque Application Point
502/Fifth Torque Application Point
503/Fixed Head Portion Inner Drive Profile
504/Outer Swivel Joint Layer
505/Fixed Head Portion Pivot Pin Bore
506/Fixed Head Spring Face
507/Fixed Head Distil End
60/Pivot Pin
70/Resilient Bias Means
71/Resilient Bias Legs
72/Resilient Bias U Section Spring Wire
80/Fastener
81/Hexagonal Fastener Head
82/Fastener Drive Flats
83/Fastener Driven Half Faces
84/Fastener Corner Points
85/Fastener Elongate Attachment
D/Drive Torque Direction
R/Reverse/Reposition Direction
F/Lever Arm Force
FR/Force Reaction
PF/Projected Force
CF/Clamping Force

### BRIEF DESCRIPTION OF THE DRAWINGS

A full and enabling disclosure of the present invention including the best mode thereof, directed to one of ordinary skill in the art, is set forth in the specification, which makes reference to the appended drawings, in which:

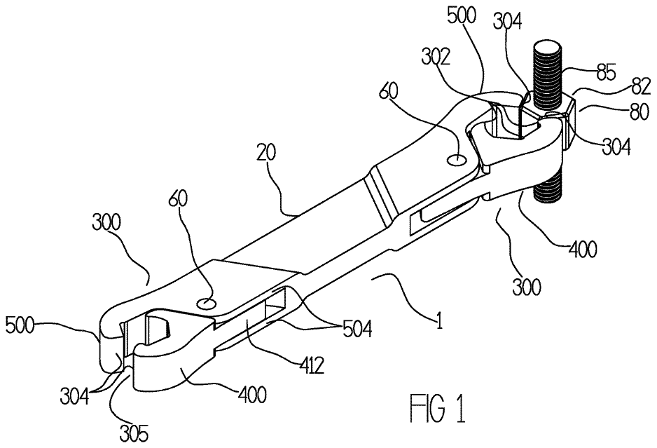

FIG. 1 is a perspective view of the push on pull off wrench in accordance with the present invention, the head portion inwardly curved profile fastener access abutting fastener drive flats.

FIG. 2 is a plan view of the push on pull off wrench, the head portion inwardly curved profile fastener access abutting fastener drive flats, in order to allow the head portion inner drive profile to directly access a fastener head.

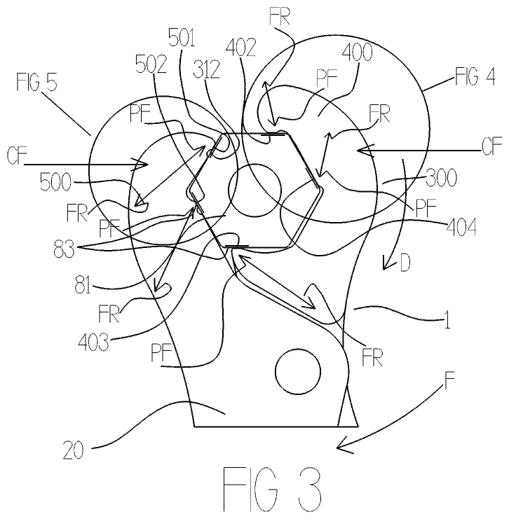

FIG. 3 is a plan view of the push on pull off wrench head the optimum five torque application points engaged upon a hexagonal fastener head in the drive direction.

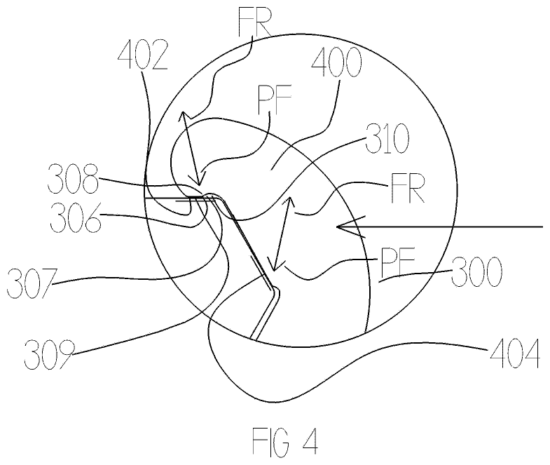

FIG. 4 is a close-up plan view of the push on pull off wrench pivotal head portions grip upon corresponding fastener driven half faces.

FIG. 5 is a close-up plan view of the push on pull off wrench fixed head portions grip upon corresponding fastener driven half faces.

FIG. 6 is a plan view of the push on pull off wrench head in the closed position showing the outline of the head portion notional hexagonal operating profile.

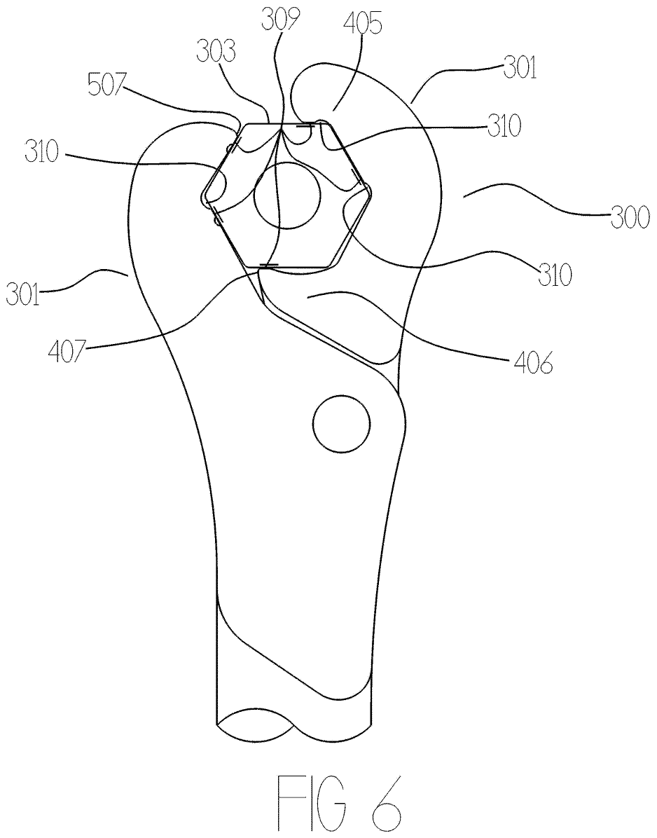

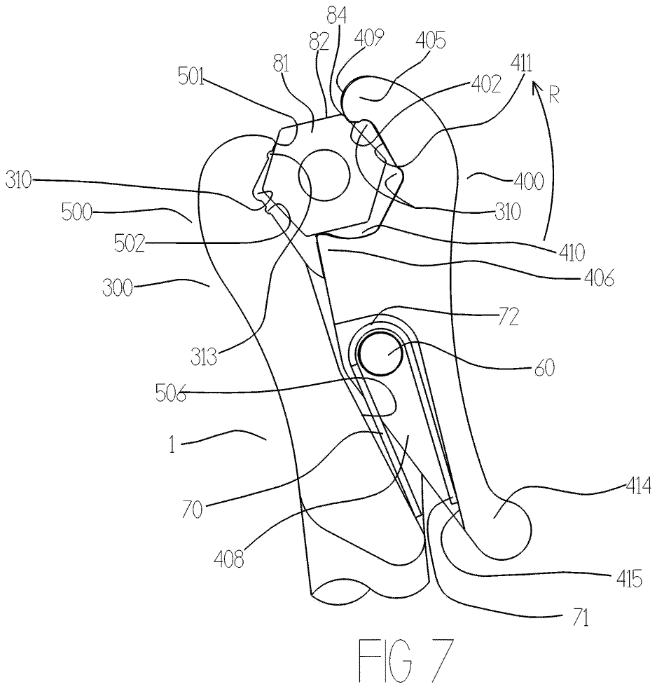

FIG. 7 is a plan view of the push on pull off wrench head engaged upon a hexagonal fastener head in the reverse direction.

FIG. 8 is a plan view of the push on pull off wrench head engaged upon a hexagonal fastener head further in the reverse direction sequence.

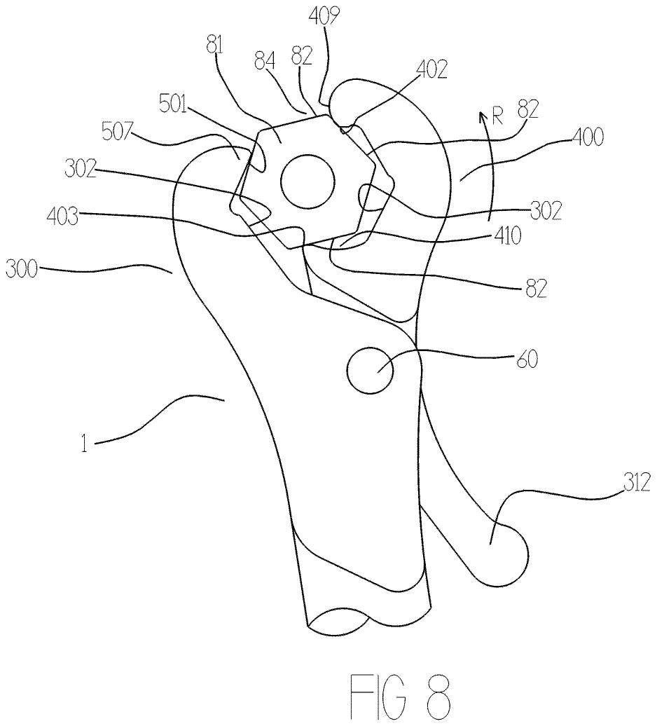

FIG. 9 is a perspective view of the push on pull off wrench dismantled into its constituent parts for demonstration purposes.

### DETAILED DESCRIPTION OF THE PREFERRED EMBODIMENTS

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as one skilled in the art to variously employ the invention.

The embodiments described herewith will be described with reference to FIGS. 1 to 9 in accordance with the invention there is provided a the push on pull off wrench 1 incorporating a resilient bias means 70 and a protective location for the resilient bias means 70 utilized.

In accordance with the invention there is provided a push on pull off wrench 1 having a head portion 300 adapted to engage and apply torque in particular but not exclusively to such as a brake pipe fitting, or flare nut attached to a tube or pipe hereinafter termed a fastener 80 and a turning means 20 for operating said head portion 300. Said head portion 300 being in two main pieces, a pivotal head portion 400 attached to a fixed head portion 500 by a pivot pin 60 said pivotal head portion 400 further resiliently urged towards the closed position by a resilient bias means 70, said pivotal head portion 400 having first 402, second 403 and third 404 torque application points indented within the pivotal head portion inner drive profile 401 for engagement with the normally hexagonally faceted flare nut, hydro-vac, plain fastener or any nut type pipe connector fitting drive surfaces, hereinafter termed a fastener 80 head 81 to be worked, the fixed head portion 500 inner drive profile 503 having further compatible fourth 501 and fifth 502 torque application points;
In use said head portion 300 in one iteration is opened by the application of finger or thumb pressure to the push switch actuator 414, thereby swivelling open the pivotal head portion 400 against the resilient bias means 70, allowing the fastener head 81 to be worked to directly access the head portion inner operating profile 302. When the finger pressure is released the pivotal head portion 400 automatically closes towards the fixed head portion 500, further operation of the turning means 20 in the drive direction D urges the fastener drive flats 82 into engagement with the pivotal head portion said torque application points 402, 403 and 404. Only the hexagonal fastener head 81, driven half faces 83 are therefore now engaged by the pivotal head portion 400 said first 402, second 403 and third 404 torque application points, engaging the said hexagonal fastener head 81 within the pivotal head portion inner drive profile 401. The pivotal head portion 400 with its incumbent fastener head 81 as it pivots around the pivot pin 60 is then forced towards the fixed head portion inner drive profile 503 said forth 501 and fifth 502 torque application points, resulting in a very robust engagement of the fastener 80 to be worked by said head portion inner operating profile 302;
When said push on pull off wrench 1 is operated in the reverse or reposition direction R the pivotal head portion 400 first swivels open around the pivot pin 60 against the resistance of the resilient bias means 70 until the pivotal head portion said torque application points 402, 403 and 404 loosen their grip upon the corresponding fastener drive flats 82. The pivotal head portion 400, inner drive profile 401 adjoining the second 403 and third 404 torque application points, concave arcuate corner profile 310, is scalloped out for the formation of an arcuate pathway 410 for the required passage of the adjacent fastener corner point 84, allowing the pivotal head portion 400 inner drive profile 401 to be “ratcheted” in the reverse or reposition R manner about the worked fastener driven half faces 83 to different drive torque direction D positions without removing the wrench head portion 300 completely from the corresponding fastener head 81, as the head portion 300 is reversed or repositioned R upon the worked hexagonal fastener head 81, the abutting fastener corner point 84 against the corresponding planar guide face 411 situated between the second 403 and third 404 torque application point concave arcuate corner profiles 310 further help urge the adjoining fastener drive flat 82 to pivot around the first torque application point 402 first jaw rolling face 409 whilst the directly opposing fastener corner point 84 can easily travel outwards from the confines of the pivotal head portion inner drive profile 401 via said arcuate pathway 410 indented between said second 403 and third 404 torque application point concave arcuate corner profile 310;
FIG. 1 further illustrates the push on pull off wrench 1 head portion inwardly curved profile fastener access 304 pressed against a fastener 80 drive flats 82, swivelling the pivotal head portion 400 open around the pivot pin 60, allowing the fastener 80, drive flats 82 to directly access the head portion 300 inner operating profile 302 via the opening head portion fastener access gap 305. Further denoting the fixed head portion 500 outer swivel joints 504, pivotal head portion 400 inner swivel layer 412, also the fastener elongate attachment 85 and turning means 20.

FIG. 2 further shows the push on pull off wrench 1 whereas there is no requirement for a push switch actuator 414 (not shown). The remote engagement function is operable by merely pushing the inwardly curved fastener access outer profile 304 against the hexagonal fastener head 81 drive flats 82 to be worked, the pivotal head portion 400 illustrated swivelling open around the pivot pin 60 against the resilient bias means 70 (not shown). The torque application point radiused leading edges 306 are even further denoted.

FIG. 3 further shows the push on pull off wrench 1 pivotal and fixed head portions 400, 500 closed upon fastener driven half faces 83 as lever arm force F is applied to the turning means 20 in the drive torque direction D, the resultant clamping force CF provides robust grip by the first 402, second 403, third 404, fourth 501 and fifth 502 torque application points upon the fastener driven half faces 83, said torque application points 402, 403, 404, 501 and 502 engaging each corresponding fastener driven half face in the direction of the projected force PF application, the occurring force reactions FR within the pivotal head portion 400 usefully projected into the deep robust head portion outer profile 301.

FIG. 4 further shows in close up the pivotal head portions 400 contact by its first 402, second 403 and third 404 torque application points, upon corresponding fastener driven half faces 83. Further displayed are the torque application point radiused leading edge 306 front aspect 307, rear aspect 308, torque application flat faces 309 and arcuate recesses 312 also shown are concave arcuate corner profiles 310.

FIG. 5 even further shows in close up, the fixed head portions 500 contact by its fourth 501 and fifth 502 torque application points, upon corresponding fastener driven half faces 83. Further displayed are the torque application point radiused leading edge 306, front aspect 307, rear aspect 308, flat faces 309 and concave arcuate corner profiles 310.

FIG. 6 further shows the head portion 300 illustrating its notionally hexagonal operating profile 303, torque application point flat faces 309, concave arcuate corner profiles 310, first jaw 405, second jaw 406, second jaw outer point 407 and fixed head distil end 507, all head portion inner operating profile radii chosen to diminish the chance of stress cracking.

FIG. 7 illustrates the push on pull off wrench 1, head portion 300 with the uppermost fixed head portion 500 outer swivel joint layer 504 removed in order to illustrate the pivotal head portion 400 inner swivel layer 412 with its resilient bias retaining slot 408 and incumbent resilient bias means 70 U section spring wire 72 fitted around the pivot pin 60 with its resilient bias legs 71 resiliently acting against the fixed head spring face 506 and the opposing resilient bias wall 415. The push on pull off wrench 1, operated in the reverse or reposition direction R the pivotal head portion 400 swivelling around the pivot pin 60 against the resilient bias means 70 as the fastener head 81 corner points 84 act in particular against the pivotal head portion 400 inner drive profile 401 planar guide face 411, the arcuate pathway 410 and the fourth torque application point 501, an adjoining fastener drive flat 82 further rotating around the first jaw 405 rolling face 409. Further displayed are the concave arcuate corner profiles 310, fifth torque application point 502, torque application point arcuate recesses 313 and the second jaw 406.

FIG. 8 illustrates the push on pull off wrench 1, even further operated in the reverse or reposition direction R, the hexagonal fastener head 81 fastener drive flats 82 abutting the first jaw rolling face 409, second torque application point 403 and the fourth torque application point 501 within the fixed head distil end 507. Further displayed are the head portion 300 inner operating profile 302, pivotal head portion 400 planar guide face 411, arcuate pathway and first torque application point 402, pivot pin 60, and the optional push switch actuator 414.

FIG. 9 shows the push on pull off wrench 1 dismantled into its constituent parts for demonstration purposes. Displaying the turning means 20, pivotal head portion 400, inner drive profile 401, first torque application point 402, second torque application point 403, third torque application point 404, first jaw 405, second jaw 406, resilient bias retaining slot 408, first jaw rolling face 409, inner swivel layer 412, pivot pin bore 413 and push switch actuator 414. Fixed head portion 500, fourth torque application point 501 and fifth torque application point 502, fixed head portion inner drive profile 503, outer swivel joint layer 504, fixed head portion pivot pin bore 505, fixed head spring face 506, fixed head distil end 507 and pivot pin 60, resilient bias means 70 and resilient bias legs 71 in best practice comprises a cost efficient U section spring wire 72.

1. A push on pull off wrench comprising:
a head portion defining an internally disposed object receiving space to receive and engage an object mounted on an elongate object; and
a handle having a length defining a lengthways direction, said handle configured to apply an input torque to said head portion to turn an object received in said object receiving space about an axis of rotation extending transverse to said lengthways direction,
wherein said head portion comprises a fixed portion fixedly connected with said handle and a movable portion pivotally connected with said fixed portion,
wherein said fixed portion has a fixed portion tip and said movable portion has a movable portion tip and said movable portion tip is movable away from said fixed portion tip against a resilient member by pivoting movement of said movable portion relative to said fixed portion and said resilient biasing member is configured to provide a biasing force that biases said movable portion towards said fixed portion,
wherein at least one of said movable portion tip and said fixed portion tip is profiled to define a camming surface, the arrangement being such that when said movable portion is pushed against a said object in a direction transverse to said lengthways direction, engagement of said object with said camming surface causes said movable portion to pivot relative to said fixed portion to move said movable portion tip away from said fixed portion tip against biasing force to allow said object to enter and be received in said object receiving face and when said object is disengaged from said movable portion tip and said fixed portion tip, said biasing force causes movable tip portion to move towards said fixed portion tip so that said object is engaged by said head portion.

2. A push on pull off wrench as claimed in claim 1, where said camming surface is defined by a curved surface portion or an angled flat surface portion.

3. A push on pull off wrench as claimed in claim 1 or 2, wherein said movable portion tip and fixed portion tip are each profiled to define a respective camming surface and camming surfaces define a channel that narrows in a radially inward direction with respect to said axis of rotation.

4. A push on pull off wrench as claimed in claim 1, 2 or 3, wherein said movable portion is provided with user operable actuator arm to apply a force to said movable portion to move said movable portion tip away from said fixed portion tip.

5. A push on pull off wrench as claimed in any one of the preceding claims, wherein said resilient member is a generally U-shaped spring.

6. A push on pull off wrench as claimed in claim 5, wherein said movable portion is pivotally connected with said fixed portion by a pivot pin, said U-shaped spring comprises an arcuate end and respective arms that project from opposite sides of aid arcuate end, said arcuate end is wrapped around said pivot pin and said arms project away from said object receiving space towards said handle.

7. A push on pull off wrench as claimed in any one of the preceding claims, wherein said object receiving space is defined by a plurality of inwardly facing gripping surfaces defined by said movable portion, said fixed portion defines a first gripping surface disposed at said fixed portion tip, said movable portion defines a second gripping surface disposed at said movable portion tip and said first and second gripping surfaces are mutually inclined in a direction radially outwardly with respect to said axis of rotation, whereby said movable portion tip can be moved away from said fixed portion tip against said biasing force by pulling said handle in a direction transverse to said axis of rotation an object received in said object receiving space to press said object against said first and second gripping surfaces.

8. A push on pull off wrench 1 comprises;
a push on pull off wrench 1 having a head portion 300 adapted to engage and apply torque to a fastener 80 such as a brake pipe fitting, or flare nut attached to a tube or pipe hereafter termed a fastener elongate attachment 85 and a turning means 20 for operating said head portion 300;
said head portion 300 being in two main pieces, a first pivotal head portion 400 rotationally attached in the same plane to a second fixed head portion 500 by a pivot pin 60 and resiliently urged towards the closed position by a resilient bias means 70;
the opening function optionally operable towards the open position against the resilient bias means 70, by a push switch actuator incorporated within the pivotal head portion 400;
wherein the head portion 300 incorporates an access gap 305 and in best practice an inwardly curved fastener access profile 304, as the push on pull off wrench 1, head portion 300 inwardly curved fastener access profile 304, is urged against the fastener drive flats 82 the pivotal head portion 400 opens without the any requirement of a push switch actuation portion, against the resilience of the resilient bias means 70, the pivotal head portion 400 opening sufficiently to allow the fastener drive flats 82 to be directly circumnavigated, then encompassed by the head portion inner operating profile 302, in order to immediately engage the fastener drive flats 82 to be worked without first overcoming any associated fastener elongate attachment 85.

9. A push on pull off wrench 1 as in claimed in claim 8, comprises a head portion 300 inwardly curved fastener access profile 304, wherein the curved fastener access profile 304 is replaced by an angled fastener access profile 311.

10. A push on pull off wrench 1 as in claimed in claim 8 or 9, comprises;
a resiliently closed head portion 300 characterised wherein as the push on pull off wrench 1 has no requirement for any closure locking arrangement, removal of the hexagonal fastener head 81 from the head portion 300 is further facilitated by merely pulling the turning means 20 whilst slightly biasing said turning means 20, the operator slightly biasing the push on pull off wrench 1 in the reverse or reposition direction R and merely pulling the push on pull off wrench 1 outwardly from the previously engaged hexagonal fastener head 81.

11. A push on pull off wrench 1 as claimed in claim 8, 9 or 10, wherein:
the projected force PF applied to the fastener head driven half faces 83, is characterised wherein the projected force PF is concentrated by the use of five, separate first 402, second 403, third 404, fourth 501 and fifth 502 torque application points, one per corresponding fastener driven half face 83, the torque application point flat faces 309 and radiused leading edges 306 gripping the matching fastener driven half faces 83 of the fastener drive flats 82;
when used on properly sized undamaged hexagonal fastener heads 81 at generally equidistant points from the operated fastener corner points 84 within the length of the operated fastener driven half faces 83, in order to equalize the projected force PF that can be applied to operate the worked fastener head 81, whilst minimizing the damage to either the head portion 300 said torque application points 402, 403, 404, 501 and 502 or fastener driven half faces 83 or corner points 84, the optimum point of engagement between the torque application points radiused leading edges 306 and the driven half faces 83 of the operated fastener drive flats 82, when used on properly sized undamaged fastener heads 81 being approximately 8-20% of the length of the operated fastener drive flat 82 from said fastener corner points 84 and in best practice requires to be no more than 4 mm in from the adjoining fastener corner points 84 on even the largest head portion 300 sizes.

12. A push on pull off wrench 1 as claimed in any one of claims 8 to 11, wherein:
the pivotal head portion 400 when engaged and operated in the drive torque direction D upon a correspondingly sized hexagonal fastener head 82, characterised wherein the pivotal head portion 400, first, second and optionally third torque application points 402, 403, 404 can grip and lock onto approximately 240 deg. of the hexagonal fastener head 81 usefully retaining said fastener head 81 within the pivotal head portion inner drive profile 401, further operation of the turning means 20 in the drive torque direction D, pivots the pivotal head portion 400 with its now incumbent hexagonal fastener head 81 around the pivot pin 60 forcefully urging the converging fixed head portion 500 fourth and fifth torque application points 501, 502 against their corresponding fastener driven half faces 83 substantially further increasing by approximately 120 deg. the possible applied grip and therefore projected force PF available to operate the worked fastener 80, the greater the lever arm force F applied to the turning means 20 in the drive torque direction D the greater the clamping force CF applied between said fixed head portion 500 and said pivotal head portion 400.

13. A push on pull off wrench 1 as claimed in any one of claims 8 to 12, wherein:
in order to further install a ratchet like facility in the reverse or reposition direction R the majority of the pivotal head portion inner drive profile 401 adjoining the second torque application point 403 flat face 309 or torque application point rear aspect 308 and third torque application point 404 concave arcuate corner profile 310, is scalloped out for the formation of the arcuate pathway 410 allowing the required passage of the adjacent fastener corner point 84, permitting the push on pull off wrench 1 as the turning means 20 is operated in the reverse or reposition direction R to resiliently pivot open the pivotal head portion 400 about the worked fastener driven half faces 83 to different drive positions without removing the head portion 300 completely from the corresponding fastener head 81, characterized in, as the said head portion 300 is reversed or repositioned R upon the worked hexagonal fastener head 81, the abutting fastener corner point 84 against the corresponding pivotal head portion inner drive profile 401 planar guide face 411 helps urge the adjoining fastener drive flat 82 to pivot around the first jaw 405 rolling face 409 whilst the opposing fastener corner point 84 can easily travel outwards from the confines of the pivotal head inner drive profile 401 via the arcuate pathway 410 until the first torque application point 402 can engage the next available worked fastener driven half face 83, or any further worked fastener driven half face 83 as required.

14. A push on pull off wrench 1 as claimed in any one of the claims 8 to 13, wherein:
the head portion inner operating profile 302 notional hexagonal operating profile 303, has indentations at some of its vertices in the shape of concave arcuate corner profiles 310, characterised by the torque application point radiused leading edges 306 of said concave arcuate corner profiles 310, formed at the point of convergence between the torque application point flat faces 309 and concave arcuate corner profiles 310 creating low profile, first 402, third 404 and fifth 502 torque application point radiused leading edges 306, said radiused leading edges 306 along with the torque application point flat faces 309 capable of engaging correspondingly sized fastener drive flat 82 driven half faces 83 in the drive torque direction D application.

15. A push on pull off wrench 1, as claimed in any one of the claims 8 to 14, wherein when the push on pull off wrench 1 pivotal and fixed head portions 400, 500 are closed upon corresponding fastener driven half faces 83 and lever arm force F is applied to the turning means 20 in the drive torque direction D, the resultant clamping force CF provides robust grip by the first 402, second 403, third 404, fourth 501 and fifth 502 torque application points upon the fastener driven half faces 83, said torque application points 402, 403, 404, 501 and 502 engaging each corresponding fastener driven half face in the direction of the projected force PF application, the occurring force reactions FR within the pivotal head portion 400 usefully projected into the deep robust head portion outer profile 301.

16. A push on pull off wrench 1, as claimed in any one of claims 8 to 15, wherein:
the notionally hexagonal operating profile 303, head portion inner operating profile 302 can be slightly oversized compared to the hexagonal fastener head 81 worked, this allows the said worked hexagonal fastener head 81 to rotate very slightly bringing the torque application point radiused leading edges 306 to grip the corresponding fastener driven half faces 83 in an enhanced manner, this head portion inner operating profile 302 is further capable of robustly operating, damaged, 5% undersized or near undersized inch/metric fastener 80 sizes.

17. A push on pull off wrench 1, as claimed in any one of claims 8 to 16, wherein:
the head portion inner operating profile 302 is further configured to work on differing types of fastener driven half faces 83.
